(19) United States
(12) Patent Application Publication
(10) Pub. No.: US 2012/0088170 A1
(43) Pub. Date: Apr. 12, 2012

(54) Fuel cell system and method of operating the same

(76) Inventors: Jin S. Heo, Hwaseong-si (KR); Hye-jung Cho, Anyang-si (KR); Young-jae Kim, Seoul (KR)

(21) Appl. No.: 13/137,714

(22) Filed: Sep. 7, 2011

(30) Foreign Application Priority Data
Oct. 12, 2010 (KR) 10-2010-0099541

(51) Int. Cl. H01M 8/04

(52) U.S. Cl. 429/428

(57) ABSTRACT

A fuel cell system for supplying output power of at least one of a fuel cell and a battery to a load selects one of various operation modes of the fuel cell system based on a change of an output state of the fuel cell and controls the supply of the output power of each of the fuel cell and the battery to the load according to the selected operation mode.

### CROSS-REFERENCE TO RELATED APPLICATIONS

This application claims the benefit of Korean Patent Application No. 10-2010-0099541, filed on Oct. 12, 2010, in the Korean Intellectual Property Office, the disclosure of which is incorporated herein in its entirety by reference.

### BACKGROUND

1. Field

The present disclosure relates to a fuel cell system and a method of operating the same.

2. Description of the Related Art

A fuel cell corresponds to environmentally-friendly alternative energy technology of generating electrical energy from substances, such as hydrogen, plentifully existing on Earth, and has become a subject of great interest. However, the fuel cell generally has a low response speed with respect to a load change due to high impedance. To supplement this, a fuel cell system being developed includes a rechargeable secondary cell therein.

### SUMMARY

Provided are a fuel cell system capable of simultaneously securing stability thereof and durability of a battery by operating according to an actual power output state of a fuel cell and a method of operating the same.

Provided is a computer readable recording medium storing a computer readable program for executing the operating method in a computer.

Technical aspects of the presented embodiments are not limited to the above-described aspects, and other technical aspects may exist.

Additional aspects will be set forth in part in the description which follows and, in part, will be apparent from the description, or may be learned by practice of the presented embodiments.

According to an aspect, a fuel cell system for supplying output power of at least one of a fuel cell and a battery to a load, the fuel cell system including a Balance of Plants (BOP) configured to drive the fuel cell to supply power to at least one of the load and the battery, and a controller configured to control the supply of the output power of each of the fuel cell and the battery to the load by controlling an operation of the BOP according to a change of an output state of the fuel cell.

The change of the output state of the fuel cell may include a change of an output current value of the fuel cell.

The controller may be configured to control the operation of the BOP in accordance with a magnitude of an error between the output current value of the fuel cell and a predetermined target current value.

If the error is equal to or less than a threshold, the controller may be configured to control an operation amount of the BOP based on the magnitude of the error.

If the error is equal to or less than the threshold, the controller may be proportional relationship with respect to the magnitude of the error.

If the error is greater than the threshold, the controller may be configured to supply only the output power of the battery to the load and stopping the operation of the BOP.

If a total discharged power quantity of the battery according to discharging of the battery or a value corresponding to the total discharged power quantity is equal to or greater than a reference power consumption quantity, the controller may be configured to start up the fuel cell.

According to another aspect, a method of operating a fuel cell system for supplying output power of at least one of a fuel cell and a battery to a load, the method including selecting an operation mode of the fuel cell system based on a change of an output state of the fuel cell, and controlling the supply of the output power of each of the fuel cell and the battery to the load according to the selected operation mode.

The change of the output state of the fuel cell may include a change of an output current value of the fuel cell.

Selecting the operation mode may include selecting the operation mode of the fuel cell system based on a magnitude of an error between the output current value of the fuel cell and a predetermined target current value.

Selecting the operation mode of the fuel cell may include selecting a normal mode in which power is generated by the fuel cell, if the error is equal to or less than a threshold, and controlling the supply of power may include controlling an operation amount of the BOP based on the magnitude of the error according to the normal mode.

Controlling according to the normal mode may include calculating the error, and adjusting a pumping amount of a fuel pump of the BOP according to a change of the calculated error.

Selecting the operation mode of the fuel cell may include selecting a battery mode for supplying only the output power of the battery, if the error is greater than a threshold, and controlling the supply of power may include stopping an operation of the BOP according to the battery mode.

If a total discharged power quantity of the battery according to discharging of the battery or a value corresponding to the total discharged power quantity is equal to or greater than a reference power consumption quantity, the method may further include selecting a start-up mode for starting up the fuel cell.

According to another aspect, a computer readable recording medium storing a computer readable program for executing in a computer a method of operating a fuel cell system for supplying output power of at least one of a fuel cell and a battery to a load, the method including selecting one of various operation modes of the fuel cell system based on a change of an output state of the fuel cell, and controlling the supply of the output power of each of the fuel cell and the battery to the load according to the selected operation mode.

### BRIEF DESCRIPTION OF THE DRAWINGS

These and/or other aspects will become apparent and more readily appreciated from the following description of the embodiments, taken in conjunction with the accompanying drawings of which:

FIG. 1 is a graph showing a charge characteristic of a lithium battery;

FIGS. 2 and 3 are graphs showing charge characteristics of a lithium battery in a fuel cell system for driving a constant-current operation of a fuel cell;

FIG. 4 is a block diagram of a fuel cell system according to an embodiment;

FIG. 5 is a flowchart of a method of operating a fuel cell system according to an embodiment;

FIG. 6 is a detailed flowchart of a start-up mode corresponding to an operation of FIG. 5;

FIG. 7 is a detailed flowchart of a normal mode corresponding to another operation of FIG. 5;

FIG. 8 is a detailed flowchart of a battery mode corresponding to another operation of FIG. 5;

FIG. 9 is a block diagram of a fuel cell system according to another embodiment; and

FIG. 10 is a graph showing an example of input/output states of a fuel cell, a battery, and a load in the fuel cell system of FIG. 4.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. The present embodiments relate to a fuel cell system and a method of operating the same, and a detailed description of matters, such as a stack and a Balance of Plants (BOP) composing a fuel cell, well known to those of ordinary skill in a technical field to which the embodiments described below belong will be omitted to more clearly describe features of the embodiments described below. In addition, although a current and a voltage output from a fuel cell means a current and a voltage output from a stack of at least one fuel cell in a strict sense, they are simply disclosed as a current and a voltage output from a fuel cell.

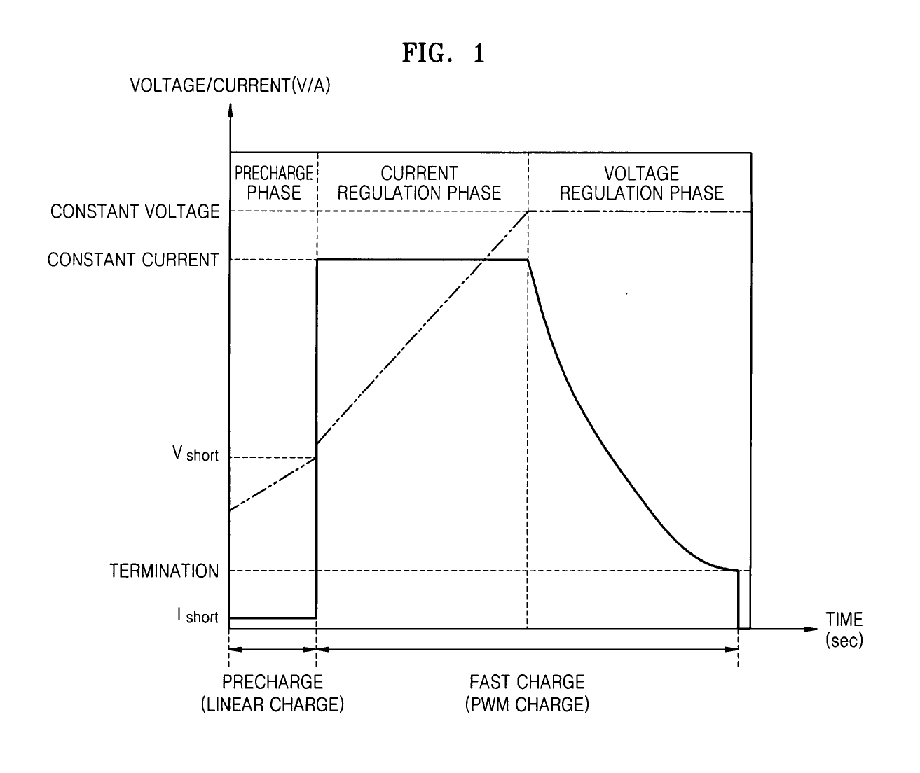

FIG. 1 is a graph showing a charge characteristic of a lithium battery. In FIG. 1, a solid line denotes a charge current, and a dotted line denotes a charge voltage. The lithium battery is a secondary battery using lithium for a cathode, and examples of the lithium battery are a lithium ion battery and a lithium polymer battery. Since the lithium battery has a relatively high energy density, the lithium battery is widely used as an auxiliary power source of a fuel cell, e.g., as a power source of a cellular phone.

Referring to FIG. 1, a charging process of the lithium battery is classified into a precharge phase, a current regulation phase, and a voltage regulation phase. In the precharge phase, a linear charge method is used, and in the current regulation phase and in the voltage regulation phase, a high-speed charge method, e.g., a Pulse Width Modulation (PWM) charge method, is used. In general, a charge limit voltage of the lithium battery is 4.2 V. If a voltage of a charging power source supplied to the lithium battery exceeds the charge limit voltage, battery performance is deteriorated. Thus, when the lithium battery is charged, the charge limit voltage may be considered.

In the precharge phase, a current and a voltage supplied to the lithium battery are to respectively have values set to Ishort and Vshort to prepare the lithium battery for charging. In this case, a voltage value of the lithium battery gradually increases to Vshort. In the current regulation phase, the voltage value of the charging power source is raised to the charge limit voltage, i.e., 4.2 V, in a state where the current value of the charging power source is maintained constant. Since the lithium battery may also be deteriorated in a case where the constant current value is excessively high, a limit current value is set by considering a performance of the lithium battery, e.g., a discharging rate. In the voltage regulation phase, the current value of the charging power source is gradually decreased according to an increase of a charging capacity of the lithium battery in a state where the voltage value of the charging power source is maintained constant, e.g., at 4.2 V.

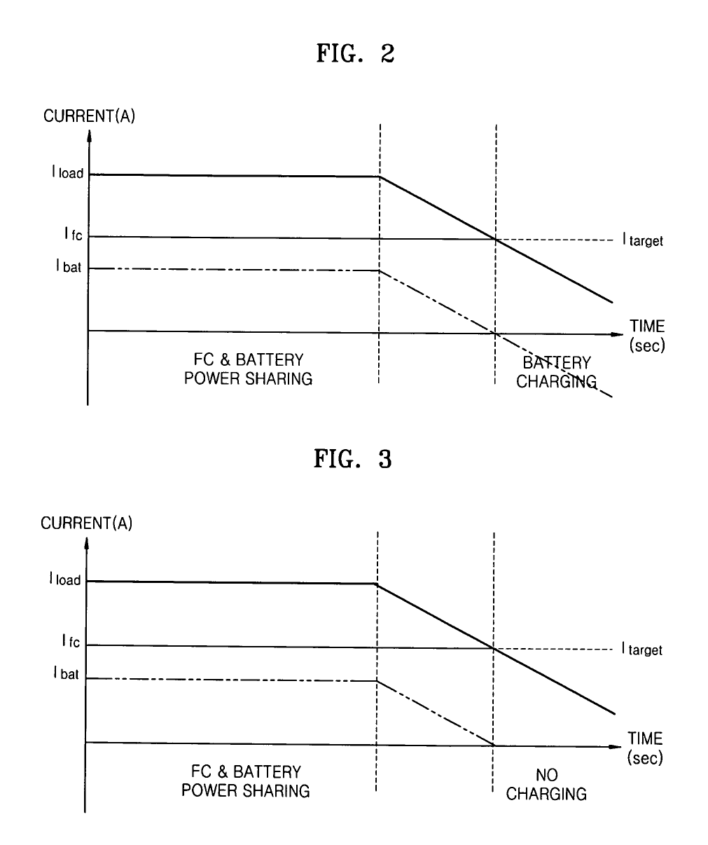

FIGS. 2 and 3 are graphs showing charge characteristics of a lithium battery in a fuel cell system for driving a constant-current operation of a fuel cell. In general, the fuel cell system drives a constant-current operation, i.e., by outputting a constant current from the fuel cell, or drives a constant-voltage operation, i.e., by outputting a constant voltage from the fuel cell. In the constant-current operation of the fuel cell, a voltage output from the fuel cell varies, and in the constant-voltage operation of the fuel cell, a current output from the fuel cell varies. In particular, the fuel cell system corresponding to FIGS. 2 and 3 has a structure in which the fuel cell acts as a main power source and the lithium battery is used to start up the fuel cell or acts as an auxiliary power source for a load. A problem that occurs due to the fuel cell system driving a constant-current operation of the fuel cell will now be described with reference to FIGS. 2 and 3.

A charging capacity of the lithium battery (when the current regulation phase shown in FIG. 1 has ended) corresponds to 80% of a maximum charging capacity of the lithium battery. FIG. 2 shows a case where the charging capacity of the lithium battery is less than 80% of the maximum charging capacity of the lithium battery. In this case, since charging of the lithium battery is performed in the current regulation phase shown in FIG. 1, with respect to a voltage and a current supplied from a charging power source to the lithium battery, a value of the supplied voltage increases to 4.2 V in a state where a value of the current is maintained constant. Referring to FIG. 2, a current supplied to a load is maintained constant and then decreases according to a change in power consumption of the load. When the current supplied to the load is maintained constant, a constant current Itarget from the fuel cell and a constant current Ibat from the lithium battery are supplied to the load at the same time. When the current supplied to the load Iload decreases, i.e., since the fuel cell system drives the constant-current operation, a constant current Itarget, i.e., Ifc, is supplied from the fuel cell to the load, while the current Ibat supplied from the lithium battery to the load decreases. In particular, if the current Iload supplied to the load decreases to less than the constant current Itarget output from the fuel cell, surplus power of the fuel cell is used to charge the lithium battery (“Battery Charging” region in FIG. 2).

FIG. 3 shows a case where the charging capacity of the lithium battery is equal to or greater than 80% of the maximum charging capacity of the lithium battery. In this case, since charging of the lithium battery is performed in the voltage regulation phase shown in FIG. 1, the current value of the charging power source gradually decreases in a state where the voltage value of the charging power source is maintained constant at 4.2 V. Referring to FIG. 3, the current supplied to the load is maintained constant and then decreases according to a change in power consumption of the load. When the current supplied to the load is maintained constant, a constant current Itarget from the fuel cell and a constant current from the lithium battery are supplied to the load at the same time. When the current supplied to the load decreases, since the fuel cell system drives the constant-current operation, the constant current Itarget is supplied from the fuel cell to the load while the current supplied from the lithium battery to the load decreases. Meanwhile, even if the current supplied to the load decreases to less than the constant current Itarget output from the fuel cell, charging of the lithium battery is not performed. In other words, when the charging capacity of the lithium battery is equal to or greater than 80% of the maximum charging capacity of the lithium battery, a charging voltage value may be maintained constant at a high voltage of 4.2 V. However, the constant voltage value cannot be output from the fuel cell since the fuel cell system drives a constant-current operation, so charging of the lithium battery is not performed. That is, if a constant-voltage operation of the fuel cell is performed to charge the lithium battery, the fuel cell system cannot drive a constant-current operation and operate at a high voltage. Therefore, a problem may occur with respect to durability of the fuel cell.

To solve the problem, a conventional method of operating a fuel cell system by using a State of Charge (SOC) of a battery has been suggested. However, the SOC of the battery may not be correctly measured and charging and discharging of the battery may be frequently performed, and therefore, a life of the battery may be rapidly reduced. In addition, if a current state of a fuel cell is not considered, fuel supplied may be excessive and water supplied may be insufficient, and therefore, a high-temperature and unstable state may occur. Therefore, example embodiments for securing stability of a fuel cell system and for increasing durability of a battery-by operating the fuel cell system based on an output state of a fuel cell will now be described.

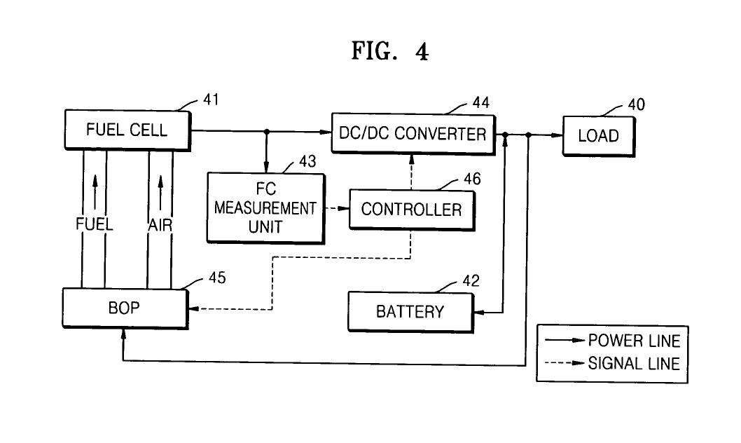

FIG. 4 is a block diagram of a fuel cell system according to an embodiment.

Referring to FIG. 4, the fuel cell system according to the current embodiment may include a fuel cell 41, a battery 42, a Fuel Cell (FC) measurement unit 43, a Direct Current (DC)/DC converter 44, a Balance of Plants (BOP) 45, and a controller 46. In particular, the fuel cell system shown in FIG. 4 has a hybrid structure in which output power of at least one of the fuel cell 41 and the battery 42 is supplied to a load 40 according to an output power change of the fuel cell 41.

The fuel cell 41 is an electricity generating device for generating DC power by directly converting chemical energy from fuel into electrical energy by using an electrochemical reaction. Examples of the fuel cell 41 are a Solid Oxide Fuel Cell (SOFC), a Polymer Electrolyte Membrane Fuel Cell (PEMFC), and a Direct Methanol Fuel Cell (DMFC). In particular, in the fuel cell system shown in FIG. 4, the fuel cell 41 supplies the generated power to at least one of the load 40 and the battery 42.

The battery 42 acts as a power source for starting up the fuel cell 41 or acts as a power source for the load 40 together with the fuel cell 41. The battery 42 used in embodiments may be a lithium battery or a rechargeable large-capacity capacitor. The battery 42 may be equipped, e.g., positioned, inside or outside of the fuel cell system shown in FIG. 4. As described above, since a battery-equipped fuel cell system can independently generate power, the battery-equipped fuel cell system can be used as a portable fuel cell system. For a fuel cell of the portable fuel cell system, a DMFC, generally having a size smaller than other types of fuel cells, is mainly used.

The FC measurement unit 43 measures an output state of the fuel cell 41. For example, the FC measurement unit 43 may measure the output state of the fuel cell 41 by measuring a value of an output current of the fuel cell 41. Alternatively, the FC measurement unit 43 may measure the output state of the fuel cell 41 by measuring a value of an output voltage of the fuel cell 41. In the specification, a case of measuring the output state of the fuel cell 41 by measuring the value of the output current of the fuel cell 41 is described as an example. It will be understood by those of ordinary skill in a technical field to which the embodiments described in the specification belong that the output state of the fuel cell 41 may be measured by using another factor instead of the above-described factor and that the embodiment described in the specification may be easily modified and designed for the other factor, e.g., by measuring output voltage.

The DC/DC converter 44 converts the output voltage of the fuel cell 41 into a voltage according to a control of the controller 46. Surplus power remaining after being supplied to the load 40 from among output power of the DC/DC converter 44 is used for charging the battery 42. The DC/DC converter 44 may change the output voltage of the fuel cell 41 according to a control of the controller 46 in such a way that a constant current is output from the fuel cell 41. This corresponds to a case where the fuel cell system drives the constant-current operation. In this case, even if power output from the fuel cell 41 varies according to a state of the fuel cell 41 or a change of the load 40, the DC/DC converter 44 may maintain the output current of the fuel cell 41 constant by changing the output voltage of the fuel cell 41. As described above, since the DC/DC converter 44 can drive the constant-current operation of the fuel cell 41 even in a state in which the load 40 changes, fuel supplied to the fuel cell 41 can be maintained constant, thereby lengthening a life of the fuel cell 41.

Alternatively, the DC/DC converter 44 may change the output voltage of the fuel cell 41 according to a control of the controller 46 in such a way that a constant voltage is input to the load 40. This corresponds to a case where the fuel cell system drives the constant-voltage operation. In this case, even if power output from the fuel cell 41 varies according to a state of the fuel cell 41 or a change of the load 40, the DC/DC converter 44 may maintain the output voltage of the fuel cell 41 constant by increasing or decreasing the output current of the fuel cell 41. As described above, since the DC/DC converter 44 can maintain the voltage input to the load 40 at a level greater than a predetermined level, the voltage input to the load 40 can be stabilized.

The BOP 45 drives the fuel cell 41 according to a control of the controller 46. In more detail, the BOP 45 includes a pump for supplying fuel, e.g., a reformed gas having a high hydrogen concentration and methanol (CH₃OH), to the fuel cell 41, a pump for supplying an oxidant, e.g., air and oxygen, for oxidizing the fuel, and a pump for supplying a coolant as peripherals for driving the fuel cell 41 according to a control of the controller 46. The fuel cell system shown in FIG. 4 corresponds to a case where the fuel cell 41 is a DMFC, wherein fuel and air are supplied to the fuel cell 41 through the BOP 45. In the fuel cell system of FIG. 4, i.e., the DMFC system, water (H₂O) needed to generate a methanol solution having a concentration required by the fuel cell 41 to generate power is not supplied from outside the system but is replenished by collecting water generated by the fuel cell 41 within the fuel cell system. The BOP 45 may further include a pump for collecting and circulating the water generated by the fuel cell 41 and a heat exchanger for collecting heat generated by the fuel cell 41.

The BOP 45 is generally driven by using power supplied from the fuel cell 41, i.e., power output from the DC/DC converter 44. However, if the power is not generated or if the power is insufficient, the BOP 45 may be driven by using power output from the battery 42. As described above, the BOP 45 drives the fuel cell 41 by supplying fuel and air to the fuel cell 41 according to a control of the controller 46. Via the supply of fuel and air, the fuel cell 41 can generate power. Meanwhile, to drive the pumps included in the BOP 45, a function of generating a control signal suitable for the pumps is required. For example, a function of generating a duty cycle indicating an on/off ratio of a pump operation and a control signal indicating a pump speed is required. A component for driving the BOP 45 may be separately illustrated in FIG. 4. However, in FIG. 4, it is assumed for simplification of the drawing that the controller 46 drives the BOP 45.

The controller 46 controls an operation of the BOP 45 according to a change of the output state of the fuel cell 41, which is measured by the FC measurement unit 43. For example, the controller 46 may calculate an error between a value of an output current of the fuel cell 41, i.e., as measured by the FC measurement unit 43, and a value of a target current, and may control an operation of the BOP 45 based on a magnitude of the calculated error. This is to properly distribute power of the fuel cell 41 and power of the battery 42 to the load 40 according to a change of the output state of the fuel cell 41 due to a change of the load 40 and a progressing level of charging of the battery 42.

If fuel and air for the fuel cell 41 are sufficiently supplied at an optimal temperature for the electrochemical reaction inside the fuel cell 41, the fuel cell 41 may be in a state in which power output therefrom is maximized. In this state, the maximum value of a current output from the fuel cell 41, which can be measured from the fuel cell 41 when the fuel cell 41 outputs the maximum amount of power, may be an example of the target current. The target current may vary according to a deterioration degree of the fuel cell 41. The deterioration of the fuel cell 41 occurs due to various causes, such as wearing of the fuel cell 41 and an environment in which the fuel cell 41 is used. In particular, the target current in the fuel cell system shown in FIG. 4 means the maximum value of a current output from the fuel cell 41, which can be measured from the fuel cell 41 when the maximum power is output from the fuel cell 41 and supplied to all of the load 40, the battery 42, and the BOP 45.

Meanwhile, as an example different from the example of using the output current value of the fuel cell 41 as an indicator of the output state of the fuel cell 41, the controller 46 may control an operation of the BOP 45 according to an error between a value of an output voltage of the fuel cell 41 and a value of a target voltage. As another example, the controller 46 may control an operation of the BOP 45 by considering both a change of the output current value of the fuel cell 41 and a change of the output voltage value of the fuel cell 41. It will be understood by those of ordinary skill in a technical field to which the embodiments described in the specification belong that other parameters may be used to indicate the output state of the fuel cell 41 instead of the change of the output current value of the fuel cell 41 and the change of the output voltage value of the fuel cell 41. Furthermore, the controller 46 may control an operation of the BOP 45 by considering both the output state of the fuel cell 41 and an output state of the battery 42.

In more detail, if the error between the output current value of the fuel cell 41 and the target current value is equal to or less than a threshold for a predetermined time, the controller 46 controls the fuel cell 41 to generate power in correspondence with power consumption of the load 40, with charged power of the battery 42, and with power consumption of the BOP 45, by controlling an operation amount of the BOP 45 based on the magnitude of the error between the output current value of the fuel cell 41 and the target current value. For example, when it is assumed that the target current value is 1.8 A, the threshold is 0.3 A, and the predetermined time is 1 minute, if the error between the output current value of the fuel cell 41 and the target current value, i.e., 1.8 A, is equal to or less than the threshold, i.e., 0.3 A, for 1 minute, the controller 46 controls the operation amount of the BOP 45 based on the magnitude of the error between the output current value of the fuel cell 41 and the target current value.

Meanwhile, a relatively big error between the output current value of the fuel cell 41 and the target current value means that a relatively low amount of power is output from the fuel cell 41. In this case, relatively low amounts of fuel and air are supplied to the fuel cell 41. On the contrary, a relatively small error between the output current value of the fuel cell 41 and the target current value means that a relatively high amount of power is output from the fuel cell 41. In this case, relatively high amounts of fuel and air are supplied to the fuel cell 41. Thus, the controller 46 adjusts pumping amounts of the fuel pump, the air pump, and so forth of the BOP 45 to be inversely proportional to the magnitude of the error between the output current value of the fuel cell 41 and the target current value. Therefore, the supply amounts of fuel, air, and so forth to the fuel cell 41 are inversely proportional to the magnitude of the error between the output current value of the fuel cell 41 and the target current value. By doing this, power is generated by the fuel cell 41 in correspondence with the power consumption of the load 40, the charged power of the battery 42, and the power consumption of the BOP 45.

The output current value of the fuel cell 41, which approaches the target current value, means that a large amount of power close to the maximum power, which can be output from the fuel cell 41, is output from the fuel cell 41 and supplied to the load 40, the battery 42, and the BOP 45. That is, the output current value of the fuel cell 41, which approaches the target current value, means that output power of the fuel cell 41 satisfies the power consumption of the load 40 and is simultaneously used to charge the battery 42.

However, when the power consumption of the load 40 rapidly increases, power of the fuel cell 41 and power of the battery 42 may be simultaneously supplied to the load 40. In this case, the battery 42 is temporarily not charged. As shown in FIG. 4, since an output line of the DC/DC converter 44 and an output line of the battery 42 are connected to the load 40, whether power of the fuel cell 41 or power of the battery 42 is output according to a change of the load 40 is determined based on a difference between an output voltage of the DC/DC converter 44, an output voltage of the battery 42, and an input voltage of the load 40.

If the battery 42 is fully charged when the error between the output current value of the fuel cell 41 and the target current value is equal to or less than the threshold, more power cannot be supplied to the battery 42. As such, if the battery 42 is fully charged, since output power of the fuel cell 41 is supplied to only the load 40 and the BOP 45, the output power of the fuel cell 41 decreases unless the load 40 is rapidly changed. The threshold means an error between an output current of the fuel cell 41 when the battery 42 is fully charged and the target current value. The threshold may be determined by measuring an output current value of the fuel cell 41 when the battery 42 is fully charged and when a predetermined load 40 is connected to the fuel cell system shown in FIG. 4.

In the fuel cell system shown in FIG. 4, to increase efficiency thereof, if the battery 42 is fully charged, power generation of the fuel cell 41 stops, and only power of the battery 42 is supplied to the load 40. Here, the efficiency of the fuel cell system means that the same power is obtained by the fuel cell system by using relatively little fuel. As described above, if the threshold is set to fully charge the battery 42, and if only power of the battery 42 is supplied to the load 40 after the battery 42 is fully charged, discharging is always performed after the battery 42 is fully charged, so the number of start-up and stop times of the fuel cell 41, which may be relatively great, can be reduced, and the number of charging and discharging times of the battery 42, which may be relatively great, can be reduced. The frequent start-up and stop of the fuel cell 41 may be an obstacle in securing a time for increasing a temperature and others of the fuel cell 41 to an optimal state and a time for collecting water in the fuel cell 41. The fuel cell system shown in FIG. 4 can remove the obstacle by reducing the number of start-up and stop times of the fuel cell 41. In addition, instability of start-up of the fuel cell system due to an insufficient charge amount of the battery 42 can be removed.

Meanwhile, the predetermined load 40 may be any one of, for example, 100%, 90%, and 80% of rated power of the load 40 connected to the fuel cell system. From among the three examples, an output current value of the fuel cell 41 measured when the predetermined load 40 is 100% of the rated power of the load 40 and is connected to the fuel cell system is the largest, and in this case, the threshold is the smallest. Thus, discharging of the battery 42 is performed immediately after the battery 42 is fully charged unless the load 40 consumes an amount of power greater than the rated power. As a result, the number of charging and discharging times of the battery 42 is larger than those of the other examples. Since the fuel cell 41 stops when the battery 42 is discharged, the number of start-up and stop times of the fuel cell 41 increases proportionally to the number of charging and discharging times of the battery 42. Since fuel for starting up the fuel cell 41 is consumed regardless of output power of the fuel cell system when the fuel cell 41 starts up, the efficiency of the fuel cell system decreases as the number of start-up and stop times of the fuel cell 41 increases.

On the contrary, an output current value of the fuel cell 41 measured when the predetermined load 40 is 80% of the rated power of the load 40 and is connected to the fuel cell system is the smallest, and in this case, the threshold is the largest. Thus, discharging of the battery 42 is performed when the load 40 consumes power less than 80% of the rated power of the load 40. That is, if the load 40 consumes power equal to or greater than 80% of the rated power of the load 40, discharging of the battery 42 is not performed. If an environment in which the fuel cell system is used is an environment in which power equal to or greater than 80% of the rated power is continuously consumed, discharging of the battery 42 is not performed even after the battery 42 is fully charged, so the efficiency of the fuel cell system decreases. Thus, the predetermined load 40 may be 90% of the rated power of the load 40 and may be connected to the fuel cell system to reduce the number of start-up and stop times of the fuel cell 41 and to fully utilize charged power of the battery 42. However, the predetermined load 40 is only an example and may be an optimal value to increase the efficiency of the fuel cell system by considering an environment in which the fuel cell system is used, a driving state of the load 40, and so forth.

If the error between the output current value of the fuel cell 41 and the target current value is greater than the threshold for the predetermined time, the controller 46 stops an operation of the BOP 45 to stop power generation of the fuel cell 41. As such, by stopping an operation of the BOP 45, according to a control of the controller 46, only power of the battery 42 is supplied to the load 40. For example, when it is assumed that the target current value is 1.8 A, the threshold is 0.3 A, and the predetermined time is 1 minute, if the error between the output current value of the fuel cell 41 and the target current value, i.e., 1.8 A, is greater than the threshold, i.e., 0.3 A, for 1 minute, that is, if the output current value of the fuel cell 41 is less than 1.5 A for 1 minute, the controller 46 stops an operation of the BOP 45. The predetermined time may prevent a case where it is determined that the battery 42 is fully charged when the error between the output current value of the fuel cell 41 and the target current value is temporarily greater than the threshold due to a momentary decrease of power consumption of the load 40. Thus, the predetermined time may be set to be a sufficiently long time by considering a change level of power consumption of the load 40. However, if the predetermined time is set to a much longer time than the change level of power consumption of the load 40, the number of discharging times of the battery 42 may be unnecessarily reduced, thereby decreasing the efficiency of the fuel cell system.

Once the operation of the BOP 45 stops, since no power is output from the fuel cell 41, charging of the battery 42 is not performed, and only discharging of the battery 42 is performed. If the battery 42 is fully discharged, no power is supplied to the load 40. Thus, the controller 46 performs start-up of the fuel cell 41 to restart power generation of the fuel cell 41 if a total discharged power quantity of the battery 42 according to the discharging of the battery 42 is equal to or greater than a reference power consumption quantity. In addition, once the operation of the BOP 45 stops, since no power is output from the fuel cell 41, power consumed by elements of the fuel cell system other than the load 40 is also supplied from charged power of the battery 42. For example, since no power is output from the fuel cell 41 when the fuel cell 41 starts up, power consumed by the BOP 45 is supplied from charged power of the battery 42. In addition, since no power is output from the fuel cell 41 when air depletion is regularly performed to maintain performance and durability of the fuel cell 41, power consumed by the BOP 45 is supplied from charged power of the battery 42. Thus, the reference power consumption quantity may be determined by considering power consumed by the BOP 45 in a start-up phase of the fuel cell 41 and the total discharged power quantity of the battery 42 used until power consumption of the load 40 and the BOP 45 are satisfied with only power of the fuel cell 41.

Meanwhile, when a device corresponding to the load 40 connected to the fuel cell system shown in FIG. 4 is changed, e.g., when the device is switched from a mobile phone to a laptop computer, power consumption of the load 40 is changed, and thus the threshold is also changed. If various kinds of loads 40 are frequently changed and connected to the fuel cell system, a method of adding a current detector (not shown) to the battery 42 and detecting the existence of a current input to the battery 42 by using the current detector may be considered. According to this method, if a current input to the battery 42 is not detected by the current detector for a predetermined time, the controller 46 stops an operation of the BOP 45. The fact that a current input to the battery 42 is not detected for the predetermined time means that the battery 42 is fully charged.

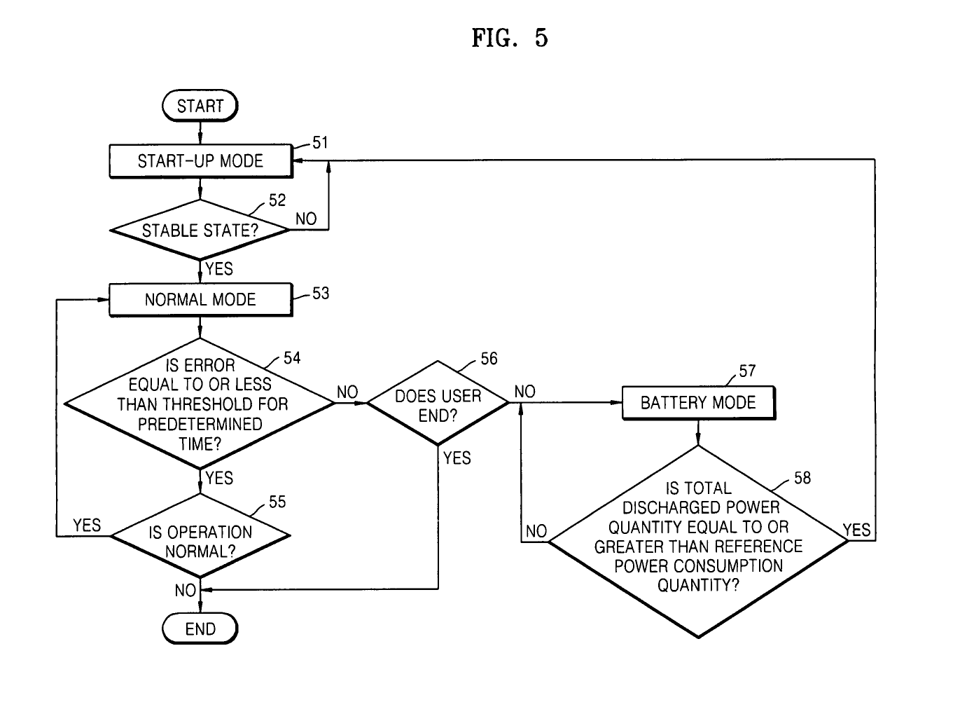

FIG. 5 is a flowchart of a method of operating a fuel cell system according to an embodiment. Referring to FIG. 5, the method of operating the fuel cell system according to the current embodiment includes operations sequentially processed by the controller 46. Thus, although omitted hereinafter, the disclosure regarding the fuel cell system shown in FIG. 4 is also applied to the method of operating the fuel cell system according to the current embodiment. In particular, the embodiment shown in FIG. 5 corresponds to an operation of the controller 46 of properly distributing power of the fuel cell 41 and power of the battery 42 to the load 40 according to a change of output power of the fuel cell 41.

Referring to FIG. 5, in operation 51, the controller 46 controls an operation of the BOP 45 according to a start-up mode for starting up the fuel cell 41 among various operation modes of the fuel cell system. That is, the controller 46 controls operations, e.g., of the fuel pump, the air pump, and so forth, of the BOP 45 to gradually increase amounts, e.g., of fuel, air, and so forth, supplied to the fuel cell 41 to start up the fuel cell 41 according to the start-up mode. Accordingly, the output current value of the fuel cell 41 is gradually increased.

In operation 52, when the current output value of the fuel cell 41, which is measured by the FC measurement unit 43, is in a stable state corresponding to 50% of a target current value, the controller 46 selects a normal mode in which power is generated by the fuel cell 41 in correspondence with power consumption of the load 40, charged power of the battery 42, and power consumption of the BOP 45 among the various operation modes of the fuel cell system, and proceeds to operation 53. Otherwise, the controller 46 proceeds back to operation 51. The stable state of the fuel cell 41 means a state in which an electrochemical reaction environment, e.g., a catalyst temperature, in the fuel cell 41 is stable enough to smoothly respond to a change of the power consumption of the load 40. Thus, the 50% of the target current value is only an example and may be changed according to a state of the fuel cell 41.

In operation 53, the controller 46 changes an operation mode of the fuel cell system from the start-up mode to the normal mode and controls an operation of the BOP 45 according to the normal mode. That is, the controller 46 controls an operation amount of the BOP 45, e.g., pumping amounts of the air and/or fuel, based on the magnitude of an error between the output current of the fuel cell 41 and the target current value so that power is generated by the fuel cell 41 in correspondence with the power consumption of the load 40, the charged power of the battery 42, and the power consumption of the BOP 45 according to the normal mode.

Power output from the DC/DC converter 44 may be supplied to both the load 40 and the battery 42 or to only the load 40 according to a potential difference between an output voltage of the DC/DC converter 44 and an output voltage of the battery 42. Power output from the DC/DC converter 44 to the battery 42 is used to charge the battery 42. When the power consumption of the load 40 rapidly increases, both power of the fuel cell 41 and power of the battery 42 may be supplied to the load 40 at the same time. If the output voltage of the battery 42 is lowered according to discharge of the battery 42, or if the power consumption of the load 40 decreases according to a change of the load 40, the output voltage of the DC/DC converter 44 is higher than the output voltage of the battery 42. In this case, an output current of the DC/DC converter 44 flows to the battery 42, thereby charging the battery 42. Power used to charge the battery 42 is surplus power remaining after being supplied to the load 40 and the BOP 45 among power generated by the fuel cell 41.

In operation 54, if the error between the output current of the fuel cell 41 and the target current value is equal to or less than a threshold for a predetermined time, the controller 46 proceeds to operation 55. Otherwise, the controller 46 selects a battery mode for supplying only output power of the battery 42 to the load 40 among the various operation modes of the fuel cell system, and proceeds to operation 56. For example, when it is assumed that the target current value is 1.8 A, the threshold is 0.3 A, and the predetermined time is 1 minute, if the error between the output current value of the fuel cell 41 and the target current value, i.e., 1.8 A, is equal to or less than the threshold, i.e., 0.3 A, for 1 minute, i.e., if the output current value of the fuel cell 41 is equal to or greater than 1.5 A for 1 minute, the controller 46 proceeds to operation 55. Otherwise, i.e., if the output current value of the fuel cell 41 is less than 1.5 A for 1 minute, the controller 46 selects the battery mode and proceeds to operation 56.

In operation 55, the controller 46 checks operations of the fuel cell 41, the BOP 45, and others of the fuel cell system, and if it is determined that the operations of the fuel cell 41, the BOP 45, and the others are normal, the controller 46 proceeds back to operation 53. Otherwise, i.e., if it is determined that the operations of the fuel cell 41, the BOP 45, and the others are abnormal, the controller 46 terminates driving the fuel cell system.

In operation 56, the controller 46 determines whether a driving termination command of the fuel cell system is input by a user. If it is determined that the driving termination command of the fuel cell system is input, the controller 46 terminates driving the fuel cell system. Otherwise, the controller 46 proceeds to operation 57.

In operation 57, the controller 46 changes the operation mode of the fuel cell system from the normal mode to the battery mode and stops an operation of the BOP 45 according to the battery mode. That is, the controller 46 stops an operation of the BOP 45 to supply only output power of the battery 42 to the load 40 according to the battery mode. In FIG. 4, if an operation of the BOP 45 stops, the supply of fuel, air, and so forth to the fuel cell 41 stops, and as a result, no power is output from the DC/DC converter 44. Thus, in FIG. 4, if an operation of the BOP 45 stops, only power of the battery 42 connected to the load 40 is supplied to the load 40.

In operation 58, if a total discharged power quantity of the battery 42 corresponding to discharging of the battery 42 in the battery mode of operation 57 or a corresponding value is equal to or greater than a reference power consumption quantity, the controller 46 selects the start-up mode for starting up the fuel cell 41 among the various operation modes of the fuel cell system and proceeds to operation 51. Otherwise, the controller 46 proceeds back to operation 57. As described above, since it is difficult to correctly measure a State of Charge (SOC) of the battery 42 and additional measurement equipment is necessary, a power consumption quantity of the load 40 in the battery mode corresponding to the total discharged power quantity of the battery 42 may be used instead of the total discharged power quantity of the battery 42. In the battery mode, since no power is output from the fuel cell 41, the power consumption quantity of the load 40 is proportional to the total discharged power quantity of the battery 42. Instead of the power consumption quantity of the load 40, another value may correspond to the total discharged power quantity of the battery 42. For example, a power consumption quantity of the BOP 45 in the battery mode may be a value corresponding to the total discharged power quantity of the battery 42.

Meanwhile, as the interval between operations 57 and 58 is relatively short, a time at which the battery mode is to be changed to the start-up mode may be correctly detected. However, in this case, a computation amount of the controller 46 increases. Performance of a lithium battery mainly used as a battery of the fuel cell system rapidly decreases if the lithium battery is discharged more than a predetermined limit. The reference power consumption quantity is determined to prevent performance deterioration of such a battery by considering characteristics of the battery. For example, if it is assumed that a capacity of the battery 42 is 1000 mAh, the reference power consumption quantity is set to 500 mAh by considering additional discharging of the battery 42 in a next start-up phase to prevent overdischarging of the battery 42.

Even when the capacity of a battery is relatively low, since the battery can be used by properly setting the reference power consumption quantity, the low-capacity battery can be applied to the fuel cell system shown in FIG. 4, and accordingly, a price of the fuel cell system can be lowered. Furthermore, since the low-capacity battery has a relatively low weight and a relatively small size, a weight and a size of the fuel cell system can be reduced. In addition, since a charging and discharging range of the battery 42 can be freely adjusted by adjusting the reference power consumption quantity, the charging and discharging range of the battery 42 can be set to satisfy performance of the battery 42.

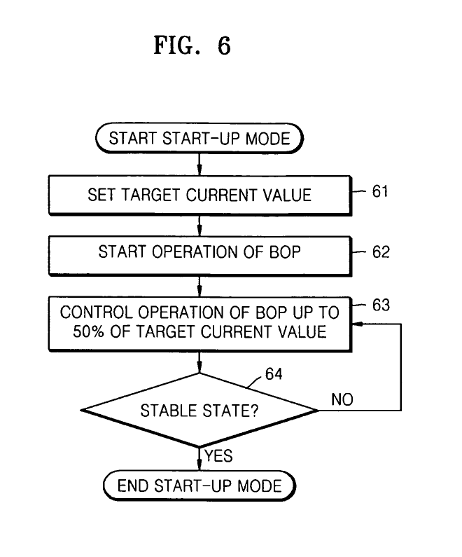

FIG. 6 is a detailed flowchart of the start-up mode corresponding to operation 51 of FIG. 5. Referring to FIG. 6, the start-up mode corresponding to operation 51 of FIG. 5 includes the following operations.

In operation 61, the controller 46 sets the target current value of the fuel cell system. For example, the controller 46 may set the target current value by receiving the target current value from the user. Alternatively, the controller 46 may diagnose a deterioration degree of the fuel cell 41 and set the target current value according to a result of the diagnosis. If the target current value suitable for a current state of the fuel cell 41 is already set like in a case where the start-up mode starts by changing the battery mode of operation 57 shown in FIG. 5 to the start-up mode, the controller 46 may start the start-up mode from operation 62 by skipping operation 61.

In operation 62, the controller 46 starts supplying fuel, air, and so forth to the fuel cell 41 by starting driving, e.g., of the fuel pump, the air pump, and so forth, of the BOP 45 to start up the fuel cell 41 and controls pumping operations, e.g., of the fuel pump, the air pump, and so forth, of the BOP 45 by referring to supply amounts, e.g., of fuel, air, and so forth, for warming up the fuel cell 41. In operation 63, the controller 46 increases the output current value of the fuel cell 41 to the target current value by gradually increasing pumping amounts, e.g., of the fuel pump, the air pump, and so forth, of the BOP 45.

Examples of a method of controlling the pumping operations of the fuel pump, the air pump, and so forth of the BOP 45 will now be described. For example, the controller 46 may adjust pumping amounts of fuel, air, and so forth supplied from the fuel pump, the air pump, and so forth by adjusting a pumping on/off ratio while constantly maintaining pumping speeds of the fuel pump, the air pump, and so forth. As another example, the controller 46 may adjust pumping amounts of fuel, air, and so forth supplied from the fuel pump, the air pump, and so forth by adjusting the pumping speeds while continuously maintaining a pumping on state of the fuel pump, the air pump, and so forth.

In operation 64, the controller 46 ends the start-up mode when the output current value of the fuel cell 41, which is measured by the FC measurement unit 43, is in the stable state corresponding to 50% of the target current value. Operation 64 corresponds to operation 52 of FIG. 5.

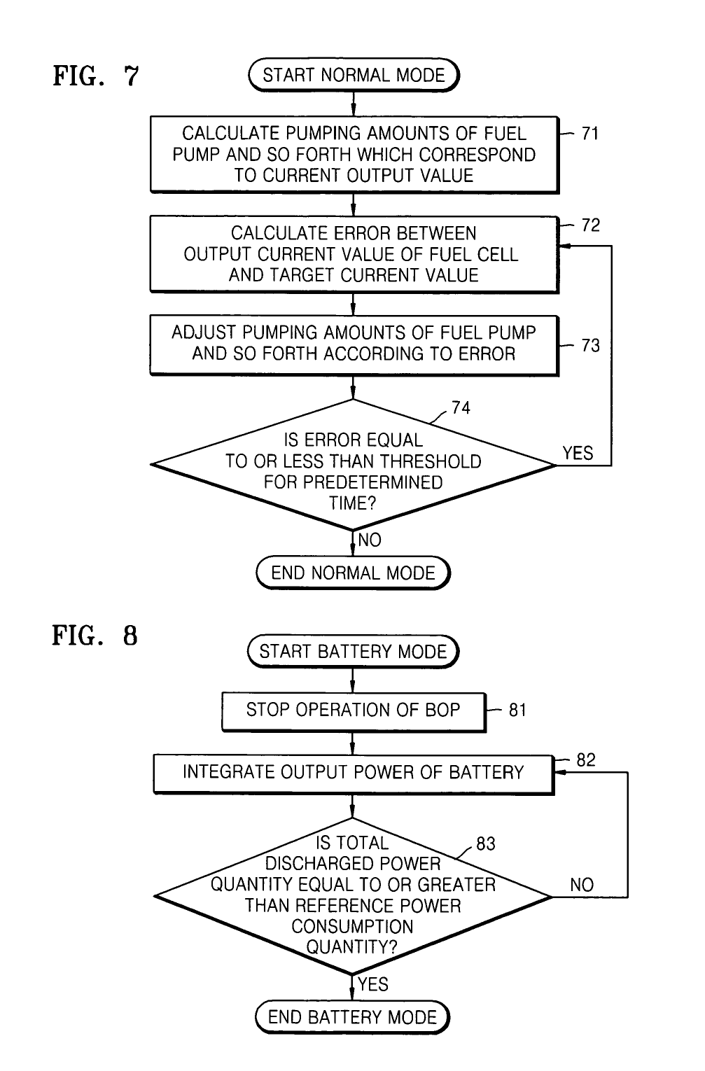

FIG. 7 is a detailed flowchart of the normal mode corresponding to operation 53 of FIG. 5. Referring to FIG. 7, the normal mode corresponding to operation 53 of FIG. 5 includes the following operations.

In operation 71, the controller 46 calculates pumping amounts, e.g., pumping on/off ratios or pumping speeds, of the fuel pump, the air pump, and so forth of the BOP 45 corresponding to the output current value of the fuel cell 41, which is measured by the FC measurement unit 43. In operation 72, the controller 46 calculates the error between the output current value of the fuel cell 41 and the target current value in a predetermined interval unit, e.g., each second. In operation 73, the controller 46 adjusts the pumping amounts of the fuel pump, the air pump, and so forth of the BOP 45 according to a change of the error calculated in operation 72. That is, if the error between the output current value of the fuel cell 41 and the target current value increases, the controller 46 determines that a state where power output from the fuel cell 41 gradually decreases is required, followed by decreasing the pumping amounts of the fuel pump, the air pump, and so forth of the BOP 45. On the contrary, if the error between the output current value of the fuel cell 41 and the target current value decreases, the controller 46 determines that a state where power output from the fuel cell 41 gradually increases is required, followed by increasing the pumping amounts of the fuel pump, the air pump, and so forth of the BOP 45.

In operation 74, if the error between the output current value of the fuel cell 41 and the target current value is equal to or less than the threshold for the predetermined time, the controller 46 proceeds back to operation 72. Otherwise, the controller 46 ends the normal mode. Operation 74 corresponds to operation 54 of FIG. 5. In FIG. 5, the controller 46 proceeds back to operation 72 after performing operation 55, in which an operation of the fuel cell system is checked, without directly proceeding back to operation 72 from operation 74. Operation 55 is a subordinate operation of regularly checking the operation of the fuel cell system, and since operation 55 does not have to be necessarily performed after operation 74, an operation corresponding to operation 55 is omitted in the embodiment shown in FIG. 7. Operation 55 may be inserted between other operations, e.g., between any two operations, in which the fuel cell 41 is being driven among the operations of FIG. 5.

FIG. 8 is a detailed flowchart of the battery mode corresponding to operation 57 of FIG. 5. Referring to FIG. 8, the battery mode corresponding to operation 57 of FIG. 5 includes the following operations.

In operation 81, the controller 46 supplies only power of the battery 42 to the load 40 by stopping an operation of the BOP 45 according to the battery mode. In operation 82, the controller 46 calculates the total discharged power quantity up to an integral time point or a corresponding value by integrating output power of the battery 42 according to discharge of the battery 42 in the battery mode or a corresponding value in a predetermined interval unit, e.g., each minute. For example, the controller 46 may calculate the power consumption quantity of the load 40 up to the integral time point by integrating the power consumption of the load 40 instead of the output power of the battery 42.

In operation 83, if the total discharged power quantity of the battery 42, which is calculated in operation 82, or the corresponding value is equal to or greater than the reference power consumption quantity, the controller 46 ends the battery mode. Otherwise, the controller 46 proceeds back to operation 82. Operation 83 corresponds to operation 58 of FIG. 5.

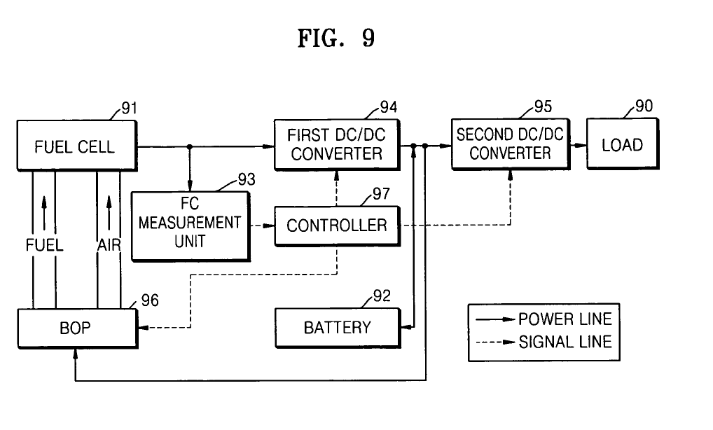

FIG. 9 is a block diagram of a fuel cell system according to another embodiment. Referring to FIG. 9, the fuel cell system according to the current embodiment includes a fuel cell 91, a battery 92, an FC measurement unit 93, a first DC/DC converter 94, a second DC/DC converter 95, a BOP 96, and a controller 97. In particular, the fuel cell system shown in FIG. 9 is a modified example of the fuel cell system shown in FIG. 4 and further includes a DC/DC converter for stabilizing a voltage input to the load 40 between the DC/DC converter 44 and the load 40 in FIG. 4. The DC/DC converter 44 of FIG. 4 corresponds to the first DC/DC converter 94, and the newly added DC/DC converter is the second DC/DC converter 95.

Like the fuel cell system shown in FIG. 4, the fuel cell system shown in FIG. 9 also has a hybrid structure in which output power of at least one of the fuel cell 91 and the battery 92 is supplied to a load 90 according to an output power change of the fuel cell 91. That is, the fuel cell 91, the battery 92, the FC measurement unit 93, the first DC/DC converter 94, the BOP 96, and the controller 97 shown in FIG. 9 perform the same functions as the fuel cell 41, the battery 42, the FC measurement unit 43, the DC/DC converter 44, the BOP 45, and the controller 46 shown in FIG. 4. Thus, only an operation of the newly added second DC/DC converter 95 will now be described. Although omitted hereinafter, the disclosure regarding the fuel cell system shown in FIG. 4 is applied to the fuel cell system shown in FIG. 9.

The second DC/DC converter 95 changes an output voltage of at least one of the fuel cell 91 and the battery 92 to a predetermined voltage required for the load 90. In the fuel cell system shown in FIG. 9, the first DC/DC converter 94 changes an output voltage of the fuel cell 91 under a control of the controller 97 in such a way that a constant current is output from the fuel cell 91. That is, the first DC/DC converter 94 drives a constant-current operation of the fuel cell 91. As described above, when the constant-current operation of the fuel cell 91 is performed, the output voltage of the fuel cell 91, i.e., an output voltage of the first DC/DC converter 94, varies. The second DC/DC converter 95 constantly maintains the varying output voltage of the first DC/DC converter 94.

The fuel cell system shown in FIG. 9 is just a modified example of the fuel cell system shown in FIG. 4. It will be understood by those of ordinary skill in a technical field to which the above-described embodiments belong that various modified examples can be easily designed within the scope of technical spirits described above besides the configurations shown in FIGS. 4 and 9. For example, two or more converters may be added to the configuration shown in FIG. 4. As another example, elements for reducing power consumption in a fuel cell system by measuring an output state of a battery or an input state of a load and turning a converter and a BOP on/off using the measured information may be added.

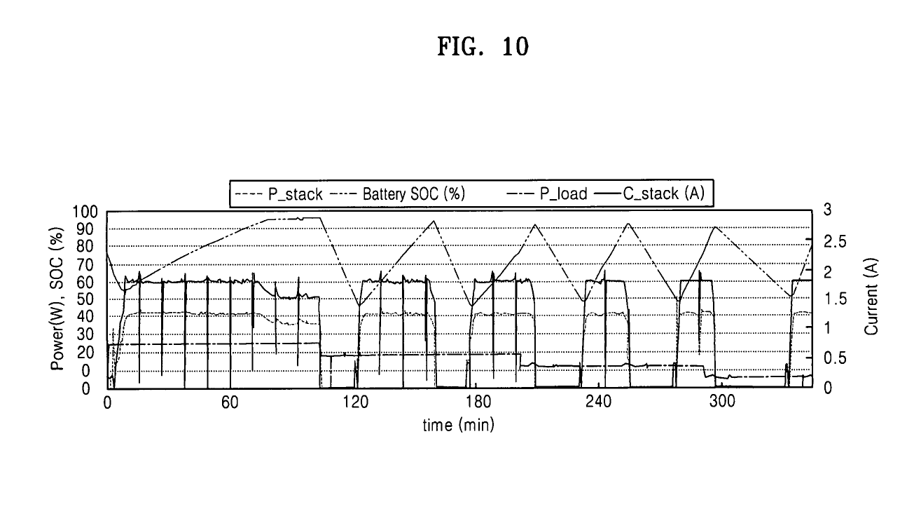

FIG. 10 is a graph showing an example of input/output states of the fuel cell 41, the battery 42, and the load 40 in the fuel cell system shown in FIG. 4. In particular, FIG. 10 shows input/output states of the fuel cell 41, the battery 42, and the load 40 measured while changing power consumption of the load 40 to 100%, 75%, 50%, and 25% of rated power of the load 40 when the rated power of the load 40 is 25 W in a fuel cell system in which the target current value is 1.8 A and the threshold is 0.3 A. In FIG. 10, a dotted line indicates output power of the fuel cell 41, an alternating long-and-two-short-dashes line indicates an SOC of the battery 42, an alternating long-and-short-dashes line indicates power consumption of the load 40, and a solid line indicates an output current of the fuel cell 41. Parts in which the solid line and the dotted line vertically fall down in intermediate portions of the graph of FIG. 10 indicate a state in which power generation of the fuel cell 41 intermittently stops due to temporary air depletion.

First, a case where the power consumption of the load 40 is set to 100% of the rated power will now be described. If output power of the fuel cell 41 is stable after start-up of the fuel cell 41 is completed, the output current of the fuel cell 41 is maintained as the target current value, i.e., 1.8 A, and the output power of the fuel cell 41 is supplied to both the load 40 and the battery 42. Referring to FIG. 10, an operation of the fuel cell system starts in a state where the battery 42 is almost fully charged. While charged power of the battery 42 is being used to drive the BOP 45 to start up the fuel cell 41, the SOC of the battery 42 decreases, and while the battery 42 is being charged, the SOC of the battery 42 increases.

While the battery 42 is being charged by a supply of power thereto, constant-current charging is changed to constant-voltage charging, thereby gradually decreasing power accepted by the battery 42. Accordingly, the output current of the fuel cell 41 also gradually decreases, and if the battery 42 is fully charged, the output power of the fuel cell 41 is supplied to only the load 40. At this time, the output current of the fuel cell 41 decreases below 1.5 A, and therefore, power generation of the fuel cell 41 stops, and only output power of the battery 42 is supplied to the load 40. Referring to FIG. 10, while the battery 42 is being charged, in a time period in which the SOC of the battery 42 approaches 100%, the output power and the output current of the fuel cell 41 gradually decrease. Thereafter, an operation mode of the fuel cell system is changed to the battery mode, and while the battery 42 is being discharged, the SOC of the battery 42 rapidly decreases.

Next, a case where the power consumption of the load 40 is rapidly decreased from 100% of the rated power to 75% will now be described. As shown in FIG. 10, since the power consumption of the load 40 is decreased after the operation mode is changed to the battery mode, only the output power of the battery 42 is supplied to the load 40. While the battery 42 is being discharged, if the discharging of the battery 42 is performed more than a reference, start-up of the fuel cell 41 is performed again to supply power to the load 40 and to charge the battery 42. Referring to FIG. 10, the SOC of the battery 42 rapidly decreases and then increases.

Likewise, even in a case where the power consumption of the load 40 is changed to 50% or 25% of the rated power, charging and discharging of the battery 42 are alternately repeated according to an output state of the fuel cell 41. Referring to FIG. 10, the SOC of the battery 42 repeats an increase and a decrease. In particular, if the power consumption of the load 40 is the rated power, charging and discharging of the battery 42 occur over the longest time period. As described above, when the power consumption of the load 40 is the rated power, the number of start-up and stop times of the fuel cell 41 is minimized, thereby highly increasing fuel efficiency of the fuel cell system and durability of the fuel cell 41.

In addition, since the change from the battery mode to the start-up mode is achieved according to a value obtained by integrating power output from the battery 42, i.e., a total discharged power quantity of the battery 42, an original capacity of the battery 42 can be fully used regardless of the power consumption of the load 40. Accordingly, frequent charging and discharging of the battery 42 can be prevented, thereby extending a life of the battery 42. Referring to FIG. 10, even in a case where the power consumption of the load 40 is changed, a time at which the battery mode is changed to the start-up mode is always a time at which the SOC of the battery is about 50% of the rated power, i.e., a time point when the power consumption of the load 40 is equal to or greater than the reference power consumption quantity.

As described above, according to the one or more of the above embodiments, a phenomenon of excessively or insufficiently supplying fuel, water, and so forth to the fuel cell 41 can be prevented by driving the fuel cell system according to a change of an output state of the fuel cell 41, thereby securing stability of the fuel cell system. In addition, since charging and discharging of the battery 42 is achieved according to the change of the output state of the fuel cell 41, frequent charging and discharging of the battery 42 can be prevented regardless of a current state of the fuel cell 41, thereby increasing durability of the battery 42.

In addition, the method of operating the fuel cell system, which is performed by the controller 46, can be written as computer programs and can be implemented in general-use digital computers that execute the programs using a computer readable recording medium. Examples of the computer readable recording medium include storage media, such as magnetic storage media (e.g., ROM, floppy disks, hard disks, etc.) and optical recording media (e.g., CD-ROMs, or DVDs).

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A fuel cell system for supplying output power of at least one of a fuel cell and a battery to a load, the fuel cell system comprising:
a Balance of Plants (BOP) configured to drive the fuel cell to supply power to at least one of the load and the battery; and
a controller configured to control the supply of the output power of each of the fuel cell and the battery to the load by controlling an operation of the BOP according to a change of an output state of the fuel cell.

2. The fuel cell system of claim 1, wherein the change of the output state of the fuel cell includes a change of an output current value of the fuel cell.

3. The fuel cell system of claim 2, wherein the controller is configured to control the operation of the BOP in accordance with a magnitude of an error between the output current value of the fuel cell and a predetermined target current value.

4. The fuel cell system of claim 3, wherein, if the error is equal to or less than a threshold, the controller is configured to control an operation amount of the BOP based on the magnitude of the error.

5. The fuel cell system of claim 4, wherein, if the error is equal to or less than the threshold, the controller is configured to adjust a supply amount of fuel to the fuel cell by the BOP in an inversely proportional relationship with respect to the magnitude of the error.

6. The fuel cell system of claim 3, wherein, if the error is greater than the threshold, the controller is configured to supply only the output power of the battery to the load and stopping the operation of the BOP.

7. The fuel cell system of claim 6, wherein, if a total discharged power quantity of the battery according to discharging of the battery or a value corresponding to the total discharged power quantity is equal to or greater than a reference power consumption quantity, the controller is configured to start up the fuel cell.

8. A method of operating a fuel cell system for supplying output power of at least one of a fuel cell and a battery to a load, the method comprising:
selecting an operation mode of the fuel cell system based on a change of an output state of the fuel cell; and
controlling the supply of the output power of each of the fuel cell and the battery to the load according to the selected operation mode.

9. The method of claim 8, wherein the change of the output state of the fuel cell includes a change of an output current value of the fuel cell.

10. The method of claim 9, wherein selecting the operation mode includes selecting the operation mode of the fuel cell system based on a magnitude of an error between the output current value of the fuel cell and a predetermined target current value.

11. The method of claim 10, wherein:
selecting the operation mode of the fuel cell includes selecting a normal mode in which power is generated by the fuel cell, if the error is equal to or less than a threshold, and
controlling the supply of power includes controlling an operation amount of the BOP based on the magnitude of the error according to the normal mode.

12. The method of claim 11, wherein controlling according to the normal mode includes:
calculating the error; and
adjusting a pumping amount of a fuel pump of the BOP according to a change of the calculated error.

13. The method of claim 10, wherein:
selecting the operation mode of the fuel cell includes selecting a battery mode for supplying only the output power of the battery, if the error is greater than a threshold, and
controlling the supply of power includes stopping an operation of the BOP according to the battery mode.

14. The method of claim 13, further comprising, if a total discharged power quantity of the battery according to discharging of the battery or a value corresponding to the total discharged power quantity is equal to or greater than a reference power consumption quantity, selecting a start-up mode for starting up the fuel cell.

15. A computer readable recording medium storing a computer readable program for executing in a computer a method of operating a fuel cell system for supplying output power of at least one of a fuel cell and a battery to a load, the method comprising:
selecting one of various operation modes of the fuel cell system based on a change of an output state of the fuel cell; and
controlling the supply of the output power of each of the fuel cell and the battery to the load according to the selected operation mode.
